(19) United States
(12) Patent Application Publication
(10) Pub. No.: US 2013/0156906 A1
(43) Pub. Date: Jun. 20, 2013

(54) Salamander Element for Closed System Oven

(71) Applicants: J.K. Raghavan, Mequon, WI (US); Thomas Wayne Rand, Cedarburg, WI (US); Nikolas W. Wagner, Waukesha, WI (US); Joshua Paul Wittig, New Berlin, WI (US)

(72) Inventors: J.K. Raghavan, Mequon, WI (US); Thomas Wayne Rand, Cedarburg, WI (US); Nikolas W. Wagner, Waukesha, WI (US); Joshua Paul Wittig, New Berlin, WI (US)

(21) Appl. No.: 13/325,581

(22) Filed: Dec. 14, 2011

(51) Int. Cl. A21B 1/00; A23L 1/01

(52) U.S. Cl. 426/243; 219/401

(57) ABSTRACT

A combination oven having a sealed cooking volume heated with forced air and steam may also provide at least one radiant heat panel positioned for direct exposure of the contained food allowing occasional browning and grilling operations or additional heat boosting.

### BACKGROUND OF THE INVENTION

The present invention relates to ovens for closed system operation and in particular to an oven providing for convection, steam and salamander cooking

Salamander ovens are special-purpose ovens having an overhead infrared heating element for toasting, grilling, or broiling. A typical salamander oven has a shallow height allowing the food placed within the oven to be directly and uniformly exposed to the radiant heating element. Often the salamander oven is open at the front to allow close visual monitoring of the cooking process. The lack of a door in a salamander oven is consistent with its function to provide a dry cooking environment that relies on radiant energy rather than heated air. Cooking with infrared radiant energy provides for extremely high food surface temperatures to enhance flavors (by the Maillard reaction), impart desired aesthetic qualities (by browning), and promote certain food textures such as crispness. The source of radiant heat may, for example, be an exposed electrical heating element (such as a Calrod™ type nichrome element) that is resistant to thermal shocks from splatter. A door may be provided in a salamander oven when other venting is provided to preserve the dry cooking environment.

Closed-system ovens, in contrast to salamander ovens, provide an oven volume that is substantially sealed to retain heat and moisture and provide energy savings. One class of closed system ovens, termed “combination ovens”, provide the ability to cook food using steam and fan driven (forced convection) hot air. The even dispersion of heat obtainable with convection and/or steam allows efficient, high density cooking of multiple food items, for example, on closely spaced stacked internal shelves. A typical combination oven thus provides sufficient height to allow food to be placed on multiple racks stacked within its volume.

The interior surface of a combination oven must be readily cleanable to prevent the carryover of tastes and flavors between different foods cooked in the oven. The heating elements, convection fan, and steam generator are normally separated from the cooking compartment by a perforated screen to protect them from direct contact with food greases and the like.

### SUMMARY OF THE INVENTION

The present invention provides a combination oven having salamander-like features through the addition of a radiant heating element that may directly expose food within the cooking volume. The heating element is sealed to provide for improved cleaning commensurate with the normal operation of a combination oven in which the transfer of food odors between cooked items must be prevented and to prevent build up of grease of food material on the radiant heater when it is not used during food cooking. Adding the ability to brown or grill food in a combination oven eliminates or reduces the need for a specialty salamander oven when a combination oven is available.

Specifically then, the present invention provides a combination oven having a housing defining a cooking volume and a door providing access to a cooking volume and sealing the cooking volume when the door is in a closed position. A heater assembly is separated from the cooking volume by a perforated panel and includes a convection heating element, a fan for circulating air heated by the convection heating element through the cooking volume, and a water jet for directing water to at least one of the convection heating elements and fan for generating steam. The oven further provides a radiant heating element within the cooking volume to direct thermal radiation to food in the cooking volume.

It is thus a feature of at least one embodiment of the invention to permit the addition of a salamander type element to a combination oven for occasional use.

The second heating element may cover substantially an entire top wall area of the cooking volume.

It is thus a feature of at least one embodiment of the invention to provide a large surface radiant source for even browning and cooking by radiant thermal energy.

In addition or alternatively, the first heating element may cover at least one sidewall of the cooking volume.

It is thus a feature of at least one embodiment of the invention to provide multidirectional browning and broiling operations.

The cooking volume may include multiple cooking racks positioned in vertical separation within the cooking volume.

It is thus a feature of at least one embodiment of the invention to provide occasional broiling capabilities in a combination oven intended for high density cooking.

The second heating element may provide a direct optical path only to food on an uppermost cooking rack when the uppermost cooking rack is substantially filled with food.

It is thus a feature of at least one embodiment of the invention to eliminate the need for a salamander type oven when occasional browning and similar operations are required.

The radiant heating element may include a heated surface generating the thermal radiation positioned behind an unheated transparent barrier.

It is thus a feature of at least one embodiment of the invention to prevent material build up on the high temperature radiant heater that may be used occasionally in between other cooking sessions. It is another feature of at least one embodiment of the invention to reduce food flavor transfer between cooking sessions caused by buildup on an unused radiant heater.

The transparent barrier may be a low thermal expansion glass providing for transmission in the infrared region.

It is thus a feature of at least one embodiment of the invention to provide a material that may maintain a relatively low oven temperature for reduced bake-on and that presents an outward, nonporous, readily cleanable surface.

The radiant heating element may be a ceramic heating element comprising internal electrical conductors encased in a heat conducting ceramic material.

It is thus a feature of at least one embodiment of the invention to permit the use of a robust, high mass, broad area infrared emitter in an oven environment.

The convection and radiant heating elements may be controlled by an electronic controller executing a stored program to permit operation of the convection heating element only, the radiant heating element only, or both the convection and radiant heating elements.

It is thus a feature of at least one embodiment of the invention to provide occasional broiler functionality in a combination oven, thus reducing the need for multiple ovens.

The stored program may provide a pulsed-on operation of the radiant heating element at a period substantially faster than a thermal time constant of the radiant heating element.

It is thus a feature of at least one embodiment of the invention to provide temperature control of a radiant element for precise cooking requirements.

The combination oven may include a door closure sensor, and the convection and radiant heating elements may be controlled by an electronic controller allowing operation of the convection heating element only when the door closure sensor indicates a closed door and allowing operation of the radiant heating element when the door closure sensor indicates an open door.

It is thus a feature of at least one embodiment of the invention to permit open door cooking for a reduced humidity cooking environment while ensuring proper sealing during combination oven operation.

The combination oven may a include temperature monitor for the cooking volume and the program may receive a selection of at least one of multiple cooking schedules from a user to control during a cooking cycle for a food, the convection heating element according to time and a temperature from the temperature monitor as indicated by the cooking schedule, and the radiant heating element according to only time for some cooking schedules and according to time and the temperature for other cooking schedules.

It is thus a feature of at least one embodiment of the invention to permit dual-modes of control (time or temperature) as may be appropriate for the convection and radiant heating elements in different cooking tasks.

The combination oven of the present invention may operate the heater assembly to heat air in the cooking volume to a predetermined temperature with the generation of steam during a first period of time and, during the first period of time, operate the radiant heating element and the convection heating element to boost the air in the cooking volume.

It is thus a feature of at least one embodiment of the invention to provide use of the radiant heater during combination oven cooking, when browning is normally impractical because of the high humidity environment, as a temperature-boosting element.

These particular features and advantages may apply to only some embodiments falling within the claims and thus do not define the scope of the invention.

### BRIEF DESCRIPTION OF THE DRAWINGS

FIG. 1 is a simplified perspective view of a combination oven in partial cutaway showing the elements of the convection fan, convection heating element (e.g., a gas heat exchanger or electric heating element) and second radiant heating element, controller board, and control panel;

FIG. 2 is a block diagram of the combination oven of FIG. 1 showing interconnection of the controller with the various elements of the combination oven;

FIG. 3 is an elevational cross-section along line 3-3 of FIG. 1 through the radiant heating element of FIG. 1 in one embodiment; and

FIG. 4 is a figure similar to that of FIG. 2 showing the use of multiple radiant heating elements within the oven cavity.

### DETAILED DESCRIPTION OF THE PREFERRED EMBODIMENT

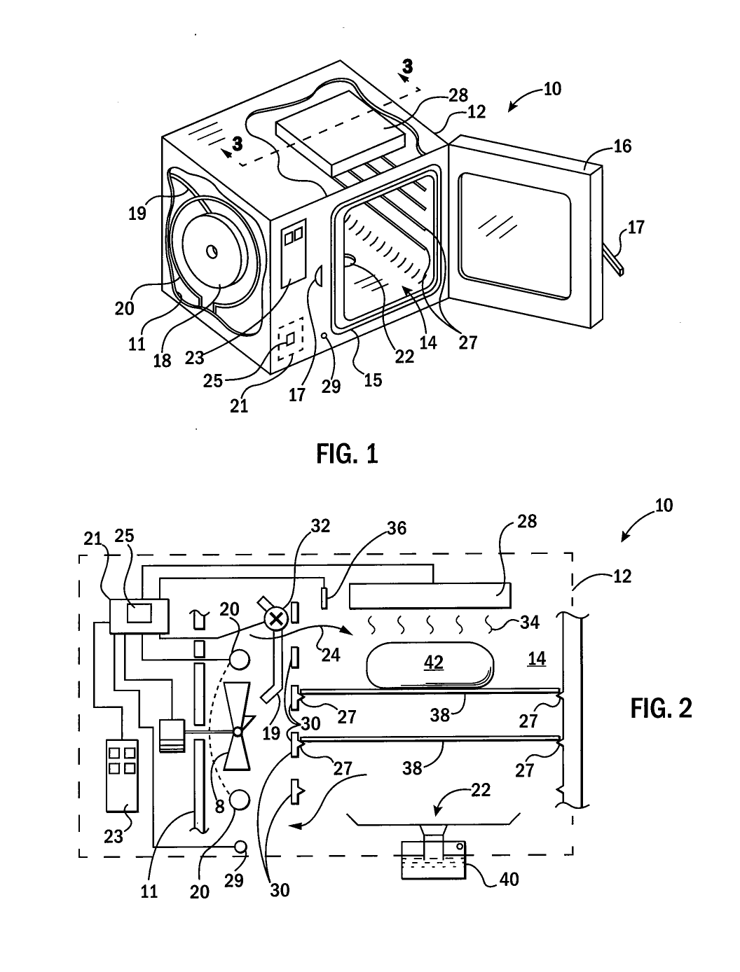

Referring now to FIG. 1, a closed-system commercial oven 10 suitable for providing steam and convection air cooking provides a housing 12 defining a cooking volume 14 open toward a front of the housing 12. The cooking volume 14 is accessible through a door 16 including a glass vision panel, the door 16 connected by a hinge at one vertical side of the cooking volume 14 to sealingly close that cooking volume 14 during cooking operations. The sealing may be promoted by a gasket 15 surrounding the opening covered by the door 16. A latch assembly 17 allows the door 16 to compress the gasket 15 and be retained in the sealed position or to be released to allow the door 16 to open.

A door sensor 29, for example a micro switch, may provide a signal indicating whether the door 16 is open or closed and sealed by the latch assembly 17.

Referring also to FIG. 2, positioned within the housing 12 and communicating with the cooking volume 14 through a perforated panel 30 is a convection fan 18 forcing a stream of air 24 across a convection heating element 20 (shown schematically) and into the cooking volume 14 providing heat for cooking items in the cooking volume 14. The convection heating element 20 may be an electric heating element such as one or more loops of a Calrod™ type heating element or a heat exchanger receiving heat from a gas flame or the like.

Generally, radiant heat from the convection heating element 20 is substantially blocked from the cooking volume 14 by the perforated panel 30 and the convection heating element 20 operates primarily through thermal conduction to air blown by the fan 18. The convection heating element 20 further provides heat for the production of steam produced by a water jet 19 controlled by a valve 32 typically impinging on the fan 18 and a portion of the convection heating element 20 proximate to the fan 18. Ovens of this type are commercially available from the Alto-Shaam Inc. of Menomonee Falls, Wis., and are described generally in U.S. Pat. No. 6,188,045 “Combination Oven with Three Stage Water Atomizer” hereby incorporated by reference.

In the present invention, a radiant heating element 28 may be positioned against the top wall of the cooking volume 14 to direct an infrared radiant energy 34 directly downward through the cooking volume 14 as will be described below. The area of the radiant heating element 28 emitting infrared radiant energy 34 extends horizontally over an area that substantially covers the top wall of the cooking volume 14.

One or more thermal sensors 36, for example platinum RTD or thermocouple elements, may communicate with the cooking volume 14 to provide an electrical signal indicating a temperature within that volume.

A controller circuit 21 within the housing 12 may provide an electronic computer or microcontroller receiving instructions from a control panel 23 accessible on the front of the oven 10, and having, for example, membrane switches or a touch panel with LCD display that may be activated by a user. As will be discussed in greater detail below, the controller circuit 21 generally provides an electronic computer executing a stored program held in a memory 25 to control the convection heating element 20, fan 18, the water jet 19, and radiant heating element 28, turning them on and off as necessary to implement a particular cooking schedule that may also be stored in the memory 25. The stored program reads signals obtained from the thermal sensors 36 and the door sensor 29 as well as from the control panel 23.

The cooking volume 14 provides a central drain 22 through which collected grease and oil from a cooked product within the cooking volume 14 may pass. The drain 22 may communicate with a trap 40, for example a water trap, to minimize the release of cooking vapor with pressurization of the sealed cooking volume 14 caused by expansion of the air and formation of steam incident to the cooking process.

The sidewalls of the cooking volume 14 may provide for rack support rails 27 holding cooking racks 38, the latter providing open shelves arranged vertically in spaced parallel relationship. Generally, food 42 on the topmost rack 38 will receive infrared radiant energy 34 but will largely block that infrared radiant energy 34 from food on lower racks 38 (only two of which are shown for clarity). The housing 12 may include a layer of insulation 11 surrounding cooking volume 14 as well as the fan 18 and the convection heating element 20 and radiant heating element 28 (in the cooking volume 14).

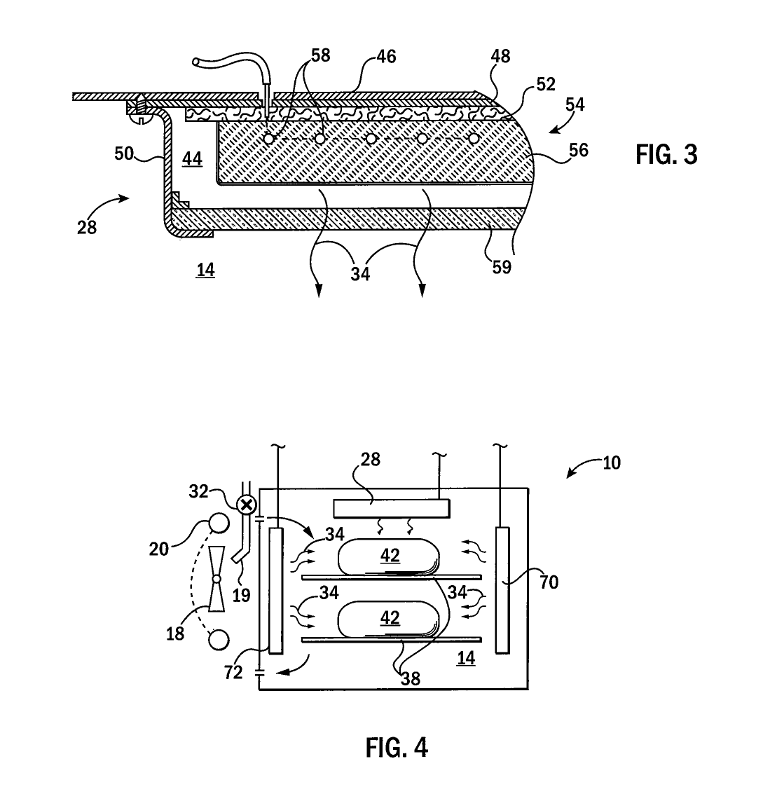

Referring now to FIG. 3, the radiant heating element 28 in one embodiment consists of a sealed chamber 44 attached at its rear upper surface to a top wall 46 of the cooking volume 14. The sealed chamber 44 may, for example, provide for an upper wall 48 of stainless steel abutting the top wall 46 and having vertical sidewalls 50 extending downward into the cooking volume 14 by a height of the radiant heating element 28. A layer of insulating material 52 (or an air gap) may separate the upper wall 48 of the sealed chamber 44 from one or more ceramic heating elements 54 held in the sealed chamber 44. Each ceramic heating element 54, as is understood in the art, comprises a block of ceramic material 56 surrounding high resistance electrical conductors 58 such as nickel chromium iron alloy wire, the latter that may receive an electrical current to produce resistive heating of the high resistance electrical conductors 58. The temperature of the electrical conductors 58 is moderated by rapid conduction of heat from the electrical conductors 58 into the ceramic material 56 which serves to spread and dissipate the heat within the ceramic material 56. The ceramic material 56 provides uniform radiant energy 34 passing downward into the cooking volume 14. Generally the ceramic material 56 presents a high mass, high power handling material that may be differentiated, for example, from a low mass, high temperature heater such as halogen light bulbs, and which provides improved temperature stability and uniformity.

The lower surface of the sealed chamber 44 may be formed of a panel of glass material 59 largely transparent to the infrared radiant energy 34 of the ceramic heating elements 54. This transparency allows the glass material 59 to remain at a substantially lower temperature than the ceramic heating elements 54. This lower temperature and the nonporous surface of the glass material 59 facilitates cleaning of surface of the glass material 59 of grease and other food materials produced during the cooking process.

The glass material 59 may, for example, be a high temperature tempered borosilicate glass or clear ceramic glass such as Robax™ transparent to infrared radiation emitted by the ceramic material 56. The glass material 59 may be gasketed and clipped to the vertical sidewalls 50 to permit differential thermal expansion and to resist infusion of water, grease and cooking fumes that might coat the ceramic material 56 causing subsequent undesired burn-off fumes. Providing a cleanable surface prevents the radiant heating element 28 from serving as a vehicle for the transfer of undesired food flavors and odors between cooking sessions.

The program in the memory 25 of the controller circuit 21 may provide for independent operation of the convection heating element 20 and radiant heating element 28 in a variety of different modes. During a normal combi-oven mode, in which broiling, browning, or toasting is not required, the radiant heating element 28 is not operated and the convection heating element 20 may be operated according to a cooking schedule identified by the control panel 23. The cooking schedule may provide, for example, a time-defined set of temperatures and optional application of steam tailored for cooking particular food materials 52 that may be identified by data entered through the control panel 23. In this regard, the controller circuit 21 controls the convection heating element 20 to provide this desired temperature of cooking volume 14 using the thermal sensor 36 in a standard feedback control loop. An internal clock (forming part of the controller circuit 21) provides the necessary time transitions. The application of steam by controlling valve 32 may be according to temperatures and/or time. Implementation of this cooking mode requires closure and sealing of the door 16 as determined by door sensor 29.

As noted, during the normal, combi-oven mode, the radiant heating element 28 is unheated and thus may condense grease and food odors produced during the cooking process that would undesirably transfer to subsequently cooked foods or that would produce a burned or smoky fumes output in later modes when the radiant heating element 28 is used. The design of the sealed chamber 44 permits it to be readily cleaned between cooking sessions with steam and cleaning agents circulated by the fan 18 as introduced through a water jet 19. Importantly, the sealed chamber 44 prevents the porous ceramic material 56 from absorbing grease and the like.

During a broiling mode, convection heating element 20 and valve 32 may be deactivated and the radiant heating element 28 used alone to provide a broiling or similar function for food materials placed on an uppermost rack 38 (uppermost being relative to any other racks that may be in position). Implementation of this cooking mode may require opening of the door 16 as determined by door sensor 29. The speed of cooking may be regulated by pulsing the electricity to the electrical conductors 58 (shown in FIG. 3) using a thyristor or similar controller switching the current on and off at a pulsing speed that exceeds the thermal time constant of the mass of the ceramic heating elements 54. The high mass of the ceramic material 56 serves to moderate its temperature with such pulsing allowing the output of uniform infrared radiant energy 34 without significant fluctuations in that output.

In a third cooking mode, convection heating element 20 and radiant heating element 28 may both be activated to provide for a rapid heat makeup (for example after the door opened) or for situations where rapid temperature rise is required. In one embodiment, the convection heating element 20 may be approximately twice the wattage of the radiant heating element 28 (e.g. 5000 watts and 2000 watts respectively) providing nearly a 50 percent heating boost when the radiant heating element 28 is activated. These periods of heat boost may be short enough to prevent significant browning of food 42 on the uppermost rack 38, such browning which, in any case, can be moderated by the high humidity within the volume 14 caused by steam injection.

Referring now to FIG. 4, in an alternative embodiment, additional radiant heaters 70 and 72 may be placed on one or both of the sidewalls of the cooking volume 14 to emit infrared radiant energy 34 laterally in-between the racks 38 for improved browning of the sides of food 42 or for rapid heat makeup as discussed above. These radiant heaters 70 and 72 may be similar in construction to the radiant heating element 28. The rack support rails 27, in this embodiment, may be constructed, for example, of welded wire forms to allow free passage of the infrared radiant energy 34 to the food 42.

Certain terminology is used herein for purposes of reference only, and thus is not intended to be limiting. For example, terms such as “upper”, “lower”, “above”, “below”, “clockwise”, and “counterclockwise” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to a controller, computer or processor or its equivalent can be understood to include one or more computational devices including microprocessors, field programmable gate arrays, and application specific integrated circuits that can implement state aware logic and that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

We claim:

1. A combination oven comprising:
an oven housing defining a cooking volume and having a door providing access to a cooking volume and sealing the cooking volume when the door is in a closed position;
a heater assembly separated from the cooking volume by a perforated panel, the heater assembly including a first heating element, a fan for circulating air heated by the first heating element through the cooking volume and a water jet for directing water to at least one of the first heating element and fan for generating steam; and
a second heating element within the cooking volume to direct thermal radiation to food in the cooking volume.

2. The combination oven of claim 1 wherein a heated surface of the second heating element covers substantially an entire top wall area of the cooking volume.

3. The combination oven of claim 2 wherein the second heating element covers at least a portion of at least one sidewall of the cooking volume.

4. The combination oven of claim 1 wherein the cooking volume includes multiple cooking racks positioned in vertical separation within the cooking volume.

5. The combination oven of claim 4 wherein the second heating element provides a direct optical path only to food on an uppermost cooking rack when the uppermost cooking rack is substantially filled with food.

6. The combination oven of claim 1 wherein the second heating element is a ceramic heating element comprising internal electrical conductors encased in a heat conducting ceramic material.

7. The combination oven of claim 1 wherein the second heating element includes a heated surface generating the thermal radiation positioned behind an unheated transparent barrier.

8. The combination oven of claim 7 wherein the transparent barrier is a low thermal expansion glass providing for transmission in the infrared region.

9. The combination oven of claim 7 wherein the second heating element is a ceramic heating element comprising internal electrical conductors encased in a heat conducting ceramic material.

10. The combination oven of claim 1 wherein the first and second heating elements are controlled by an electronic controller executing a stored program to permit operation of the first heating element only, the second heating element only or both the first and second heating elements.

11. The combination oven of claim 10 wherein the stored program may further provide a pulsed on operation of the second heating element at a period substantially faster than a thermal time constant of the second heating element.

12. The combination oven of claim 10 further including a door closure sensor and wherein the first and second heating elements are controlled by an electronic controller allowing operation of the first heating element only when the door closure sensor indicates a closed door and allowing operation of the second heating element when the door closure sensor indicates an open door.

13. The combination oven of claim 10 further including a temperature monitor for the cooking volume and wherein the stored program receives a selection of at least one of multiple cooking schedules from a user to control during a cooking cycle for a food, the first heating element according to time and a temperature from the temperature monitor as indicated by the cooking schedule, and the second heating element according to only time for some cooking schedules and according to time and the temperature for other cooking schedules.

14. A method of cooking employing an oven housing defining a cooking volume and having a door providing access to a cooking volume and sealing the cooking volume when the door is in a closed position, the oven having a heater assembly separated from the cooking volume by a perforated panel, the heater assembly including a first heating element, a fan for circulating air heated by the first heating element through the cooking volume and a water jet for directing water to at least one of the first heating element and fan for generating steam; and the oven further having a second heating element within the cooking volume to direct thermal radiation to food in the cooking volume, comprising the steps of:
(1) operating the heater assembly to heat air in the cooking volume to a predetermined temperature with a generation of steam during a first period of time; and
(2) during the first period of time, operating the second heating element and the first heating element to boost the air in the cooking volume.

15. A method of cooking employing an oven housing defining a cooking volume and having a door providing access to a cooking volume and sealing the cooking volume when the door is in a closed position, the oven having a heater assembly separated from the cooking volume by a perforated panel, the heater assembly including a first heating element, a fan for circulating air heated by the first heating element through the cooking volume and a water jet for directing water to at least one of the first heating element and fan for generating steam; and the oven further having a second heating element within the cooking volume to direct thermal radiation to food in the cooking volume, comprising the step of:
operating the second heating element only with the door open to cook foods in the cooking volume.
